(19) United States
(12) Patent Application Publication
(10) Pub. No.: US 2015/0368155 A1
(43) Pub. Date: Dec. 24, 2015

(54) HIGH CARBON CELLULAR CONCRETE

(71) Applicant: Cellular Concrete, LLC, Evergreen, CO (US)

(72) Inventors: Brian P. Masloff, Westminster, CO (US); Milton Gomez, Macungie, PA (US)

(21) Appl. No.: 14/743,537

(22) Filed: Jun. 18, 2015

Related U.S. Application Data
(60) Provisional application No. 62/013,645, filed on Jun. 18, 2014.

(51) Int. Cl. C04B 7/26

(52) U.S. Cl. CPC C04B 7/26

(57) ABSTRACT

Implementations described and claimed herein provide a process for creating a high-carbon cellular concrete that may include high-carbon ash, cement, water, and surfactants to produce a high-carbon cellular concrete. The high-carbon cellular concrete wet mix maintains its cellular properties while it is placed and cures. Also, because of the gelling characteristics and viscosity of the cellular concrete wet mix, it may be placed in a manner that requires fewer lifts or stages in a placement, which may reduce time and expense. Further, the cellular concrete wet mix may travel laterally during placement without losing its cellular matrix of micro-bubbles before curing.

### CROSS-REFERENCE TO RELATED APPLICATIONS

The present application claims benefit of priority to U.S. Provisional Patent Application No. 62/013,645, entitled “High Carbon Cellular Concrete” and filed on 18 Jun. 2014, which is specifically incorporated by reference herein for all that it discloses or teaches.

### BACKGROUND

Different types of cellular concrete are useful in different circumstances. For example, pervious cellular concrete may be specified when porosity is desired to allow some air movement or facilitate the drainage and flow of water through a concrete structure. In another example, impervious cellular concrete may be specified when freeze-thaw resistance of a concrete structure is desired. Other features of pervious and/or impervious cellular concrete over traditional concrete products include, but are not limited to, improved work-ability and flow-ability during placement, increased thermal and acoustic insulating characteristics, increased energy absorption characteristics, increased yield strength, placement stability and self-leveling characteristics, fire and seismic resistance, reduced density, increased durability, and the ability for the product to self-compact during placement.

Carbon-based materials such as fly ash are commonly used in combination with cement and other materials in the creation of concrete, including cellular concrete. The use of fly ash in concrete mixtures can improve the strength and durability of the concrete. Further, because fly ash is a waste byproduct produced from the combustion of coal in power plants, it can be an inexpensive additive to a concrete mixture.

However, ash with a particularly high carbon content (i.e., fly ash with a loss on ignition “LOI” greater than 4% or 6%), sometimes referred to as “high-carbon fly ash” or “bad fly ash,” is typically not suitable for cellular concrete because it can collapse micro-bubbles that produce a cellular matrix for both pervious and impervious cellular concrete. For example, a concrete mixture with only 0.5% by weight high-carbon fly ash may collapse the micro-bubble cellular matrix in a wet cellular concrete product prior to successful placement of the cellular concrete product. As a result, conventional cellular concrete utilizes fly ashes that are relatively low in carbon content and/or a low ratio of fly ash to cement in the dry concrete mixture to avoid collapsing the cellular micro-bubble matrix when mixed with water and a foaming agent.

### SUMMARY

Implementations described and claimed herein address the foregoing problems by providing a wet high-carbon cellular concrete product comprising: water, a foaming agent, and a high-carbon ash defining greater than 2% of the cellular concrete product by weight, wherein the cellular concrete product contains a distributed array of bubbles that substantially maintain their presence in the cellular concrete product as it cures.

Implementations described and claimed herein address the foregoing problems by further providing a cured high-carbon cellular concrete product comprising: a high-carbon ash defining greater than 3% of the cellular concrete product by weight, and foaming agent residue that defines a distributed array of bubbles within the high-carbon ash.

Implementations described and claimed herein address the foregoing problems by still further providing a method of manufacturing a high-carbon cellular concrete product comprising: combining water, a foaming agent, and high-carbon ash to create a wet cellular concrete product that contains a distributed array of bubbles that substantially maintain their presence in the cellular concrete product as it cures, wherein the high-carbon ash defines greater than 2% of the cellular concrete product by weight.

### BRIEF DESCRIPTIONS OF THE DRAWINGS

FIG. 1 illustrates an example partial cross-sectional diagram of a high-carbon cellular concrete product in a wet state.

FIG. 2 illustrates an example partial cross-sectional diagram of a high-carbon cellular concrete product in a cured state.

FIG. 3 illustrates an example placement of high-carbon cellular concrete into a containment form.

FIG. 4 illustrates another example placement of high-carbon cellular concrete into a containment form.

FIG. 5 illustrates an example placement of high-carbon cellular concrete into an annular pipe setting.

FIG. 6 illustrates example operations for preparing and using high-carbon cellular concrete.

### DETAILED DESCRIPTIONS

Implementations described and claimed herein provide high-carbon cellular concrete products and various processes for creating and using the high-carbon cellular concrete products.

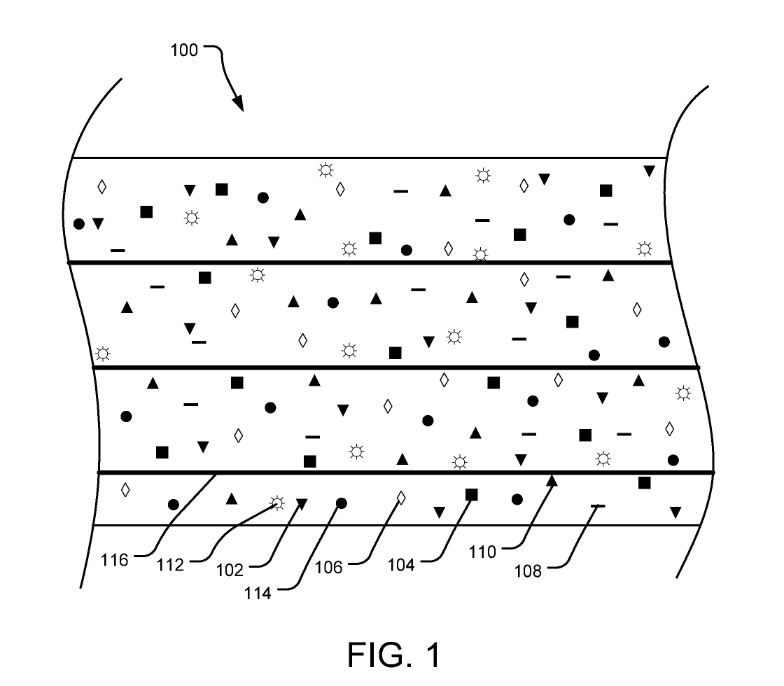

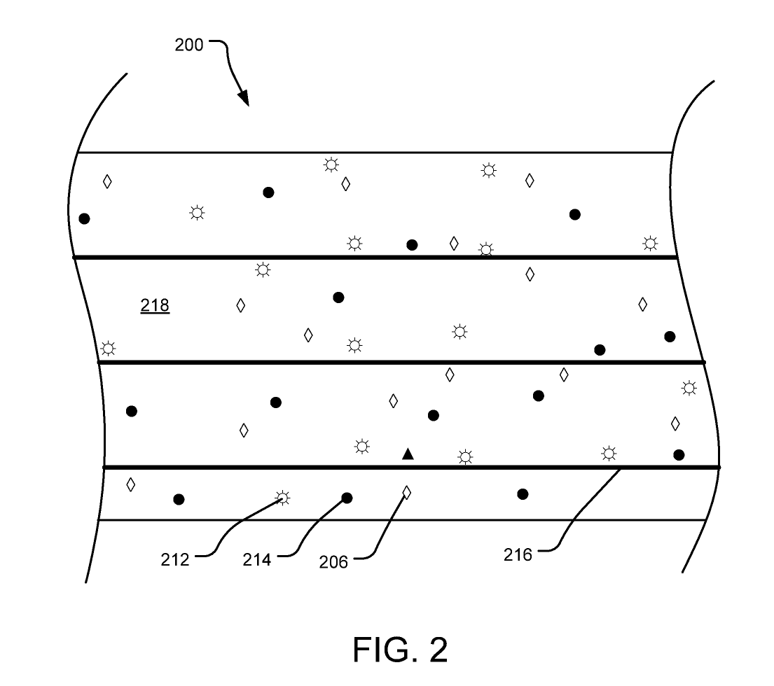

FIG. 1 illustrates an example partial cross-sectional diagram of a high-carbon cellular concrete product 100 in a wet state. The cellular concrete product 100 is a material that is composed of a variety of constituent components, some of which are illustrated by symbols in FIG. 1, as described in detail below. When the constituent components are mixed together, they form a fluid mass that is easily molded into a desired shape. Over time, some of the constituent components form a hard matrix which binds the rest of the constituent components together into a durable stone-like material with many uses (see e.g., cellular concrete product 200 of FIG. 2 in a cured state).

While the cellular concrete product 100 is shown in a partial slab form in FIG. 1, in other implementations, it may take any desired overall shape. Further, while the constituent components of cellular concrete product 100 are depicted in relative equal proportion in FIG. 1, in various implementations the proportions of each constituent component may vary widely, and in some cases constituent components may be omitted entirely.

The cellular concrete product 100 includes cement (“Portland cement”) particles (e.g., particle 102, illustrated by “▾” symbols in FIG. 1). The cement is a binder (i.e., a substance that sets and hardens and can bind other constituent materials together). Belite (2CaO.SiO₂), Alite (3CaO.SiO₂), Celite (3CaO.Al₂O₃), Brownmillerite (4CaO.Al₂O₃.Fe₂O₃) are the main chemical components present in cement. In various implementations, the cellular concrete product 100 may contain 2% to 98% by weight of cement.

The cellular concrete product 100 also includes high-carbon ash particles (e.g., particle 104, illustrated by “▪” symbols in FIG. 1). The high-carbon ash particles include one or more of fly ash (or flue-ash), bottom ash, rice hull ash, or other ashes with a loss on ignition of greater than 4%, or greater than 6%. In implementations that utilize fly-ash particles, the fly-ash may be Class F or Class C fly ash, for example, and may also be pozzolanic and/or self-cementing. SiO₂, Al₂O₃, Fe₂O₃ and occasionally CaO are the main chemical components present in fly ash, although the mineralogy of fly ash is very diverse and other chemical components may be present. Further, the fly ash may have a fineness of 45 μm or less, although the individual particle size may vary widely. In some implementations, the high-carbon ash contains between 0.5% and 7% detrimental carbon (i.e., carbon that attacks or collapses a cellular matrix of micro-bubbles created by an addition of foam to the cellular concrete product 100) by weight. In various implementations, the high-carbon ash particles may replace some or all of the cement particles in the cellular concrete product 100. In various implementations, the cellular concrete product 100 may contain 2% to 98% by weight of high-carbon ash.

The cellular concrete product 100 also includes aggregate particles (e.g., aggregate particle 106, illustrated by “—” symbols in FIG. 1). The aggregate particles may include fine and/or coarse aggregates including, but not limited to sand, gravel, clay, soil, and crushed stone. Further, the aggregate may also include recycled material (e.g., waste material from construction, demolition, and/or excavation activities). Still further, the aggregate may include manufacturing by-products (e.g., blast furnace slag and bottom ash). In various implementations, the cellular concrete product 100 may contain 2% to 98% by weight of aggregate.

The cellular concrete product 100 also includes mineral admixture particles (e.g., mineral admixture particle 108, illustrated by “—” symbols in FIG. 1). The mineral admixture(s) have pozzolanic or latent hydraulic properties and are added to the cellular concrete product 100 to improve performance characteristics of the cellular concrete product 100 and/or as a partial or full replacement for the cement (e.g., forming a blended cement). High-carbon ash (discussed in detail above) is an example mineral admixture. Other potential mineral admixture(s) include limestone, blast furnace slag, zeolite, vermiculite, pumice, and other materials with pozzolanic or latent hydraulic properties. In various implementations, the cellular concrete product 100 may contain 2% to 98% by weight of mineral admixtures other than the aforementioned high-carbon fly ash.

The cellular concrete product 100 also includes water molecules (e.g., molecule 110, illustrated by “▴” symbols in FIG. 1). Combining the water with the cement, high-carbon ash, or other mineral admixture constituent materials forms a cement paste by the process of hydration. The cement paste glues the aggregate together, fills voids within the cellular concrete product 100, and makes the cellular concrete product 100 flow in a fluidic manner. In various implementations, the cellular concrete product 100 may contain 5% to 80% by weight of the dry mixture.

The cellular concrete product 100 also includes chemical admixture molecules (e.g., chemical admixture molecule 112, illustrated by “¤” symbols in FIG. 1). The chemical admixtures are materials (typically in the form of powder or fluid) that are added to the cellular concrete product 100 to apply or enhance desired characteristics (e.g., accelerators, retarders, air entrainments, plasticizers, pigments, corrosion inhibitors, bonding agents, and pumping aids) of the cellular concrete product 100. At least one foaming agent chemical admixture is added to the cellular concrete product 100 to form a cellular matrix of micro-bubbles (see below) in the cellular concrete product 100. Further, a cellulose ether (e.g., “hydroxypropyl methylcellulose”) may be added to the cellular concrete product 100 as a thickening agent and/or a surface active agent that coats the micro-bubbles, preventing or reducing collapse of the micro-bubbles. In various implementations, the cellular concrete product 100 may contain 0.001% to 5% by volume of foaming agent(s). In various implementations, the cellular concrete product 100 may also contain 0.001% to 5% by volume of cellulose ether(s). In various implementations, the cellular concrete product 100 may further contain 0.01% to 30% by weight or 0.001% to 5% by volume of other chemical admixture(s).

The cellular concrete product 100 also includes micro-bubbles (e.g., micro-bubble 114, illustrated by “” symbols in FIG. 1), which are formed via agitation with the foaming agent acting to help form and maintain the micro-bubbles in the cellular concrete product 100 as it cures. More specifically, the micro-bubbles within the cellular concrete product 100 resist dissipation such that the cellular concrete product 100 has less than 5% loss of volume as it cures. In various implementations, the cellular concrete product 100 may contain micro-bubbles that range from 500 to 1100 microns in diameter and 10% to 98% by volume of micro-bubbles.

The proportions of the constituent materials in the cellular concrete product 100 permit the cellular concrete product 100 to have a gelling characteristic, with a viscosity significantly greater than conventional cellular concrete products (i.e., 500-90,000 cP), which allows the cellular concrete product 100 to be workable, while retaining its cellular matrix of micro-bubbles.

The cellular concrete product 100 also includes structural reinforcement (e.g., reinforcing steel rod 116). The cellular concrete product 100 is naturally strong in compression when cured, as the aggregate efficiently carries a compression load on the cellular concrete product 100. However, the cellular concrete product 100 is weak in tension as the cementious constituent materials holding the aggregate in place can crack, allowing the cellular concrete product 100 to fail. The structural reinforcement adds one or more of steel reinforcing bars, steel fibers, glass fibers, or plastic fibers to carry tensile loads applied to the cellular concrete product 100.

In various implementations, the wet cellular concrete product 100 has a density ranging between 160 to 1600 kilograms per cubic meter and a slump value ranging between 2 to 11.5 (or 3 to 8).

FIG. 2 illustrates an example partial cross-sectional diagram of a high-carbon cellular concrete product 200 in a cured state. The cellular concrete product 200 is a material that is composed of a variety of constituent components, some of which are illustrated by symbols in FIG. 2, as described in detail below. When the constituent components are mixed together, they form a fluid mass that is easily molded into a desired shape (see e.g., cellular concrete product 100 of FIG. 1 in a wet state). Over time, some of the constituent components form a hard binder 218 which binds the rest of the constituent components together into a durable stone-like material with many uses.

While the cellular concrete product 200 is shown in a partial form in FIG. 2, in other implementations, the cellular concrete product 200 may take any desired overall shape. Further, while the constituent components of the cellular concrete product 200 are depicted in relative equal proportion in FIG. 2, in various implementations the proportions of each constituent component may vary widely, and in some cases constituent components may be omitted entirely. Still further, the hard binder 218 is illustrated as the space surrounding the other depicted constituent components, but the proportion of the hard binder 218 with reference to the other depicted constituent components may vary widely from that shown in FIG. 2.

The cellular concrete product 200 includes aggregate particles (e.g., aggregate particle 206, illustrated by “⋄” symbols in FIG. 2). The aggregate particles may include fine and/or coarse aggregates including, but not limited to sand, gravel, clay, soil, and crushed stone. Further, the aggregate may also include recycled material (e.g., waste material from construction, demolition, and/or excavation activities). Still further, the aggregate may include manufacturing by-products (e.g., blast furnace slag and bottom ash).

The cellular concrete product 200 also includes chemical admixture residue (e.g., chemical admixture molecule 212, illustrated by “¤” symbols in FIG. 2). At least a foaming agent chemical residue may remain within the cellular concrete product 200 after it cures, primarily surrounding the cellular matrix of micro-bubbles (see below) in the cellular concrete product 200. Further, a cellulose ether residue may also remain within the cellular concrete product 200 after it cures. However, in various implementations, some or all of the chemical admixture(s) chemically combine with other constituent materials to form the binder material 218.

The cellular concrete product 200 also includes the micro-bubbles (e.g., micro-bubble 214, illustrated by “” symbols in FIG. 2), which are formed via agitation with the foaming agent acting to help form and maintain the micro-bubbles in the cellular concrete product 200 as it cures. The micro-bubbles resist dissipation such that the cellular concrete product 200 has less than 5% loss of volume as it cures.

In some implementations, the cellular matrix of micro-bubbles may link together during a curing process to form a number of capillaries (not pictured) in the cellular concrete product 200. The capillaries may allow the cellular concrete product 200 to be pervious or semi-pervious. In other implementations, the micro-bubbles remain substantially separate and distinct, making the cellular concrete product 200 impervious.

In some implementations, the presence of the high-carbon ash in the cellular concrete product 200 reduces the average size of the micro-bubbles and makes the size of the micro-bubbles more uniform, which can increase the overall compressive strength of the cellular concrete product 200.

The cellular concrete product 200 also includes the hard binder material 218 that holds the other constituent materials together in a cured state. The hard binder material 218 is formed from chemical reactions between a combination of the cement, high-carbon ash, other mineral admixtures, and/or water, as discussed above with reference to the cellular concrete product 100 in a wet state, as shown in FIG. 1. In various implementations, the cellular concrete product 200 includes 3% to 99% by weight of high-carbon ash, which may be greater than the percent by weight of high-carbon ash of the corresponding wet cellular concrete product (see e.g., wet cellular concrete product 100 of FIG. 1). Evaporation and/or absorption of water and/or other fluids by a surrounding environment may account for the difference.

The cellular concrete product 200 also includes structural reinforcement (e.g., reinforcing steel rod 216). The cellular concrete product 200 is naturally strong in compression, as the aggregate efficiently carries a compression load on the cellular concrete product 200. However, the cellular concrete product 200 is weak in tension as the cementious constituent materials holding the aggregate in place can crack, allowing the cellular concrete product 200 to fail. The structural reinforcement adds one or more of steel reinforcing bars, steel fibers, glass fibers, or plastic fibers to carry tensile loads applied to the cellular concrete product 200.

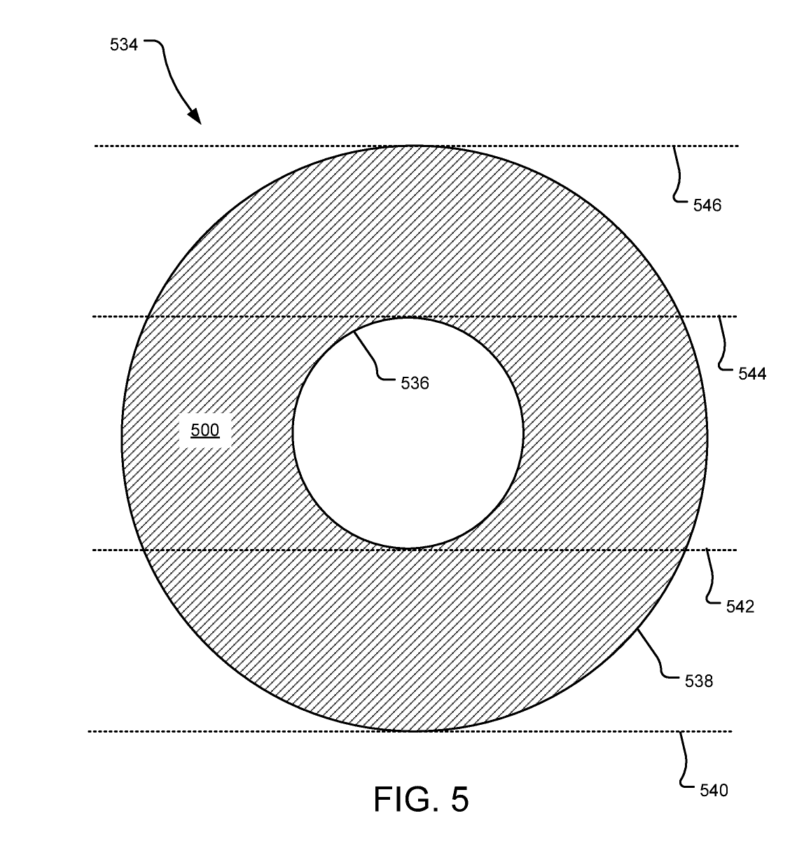

In some implementations, the cellular concrete product 200 may also have a reduced exothermic reaction compared to conventional cellular concrete as it cures. Because of the reduced exothermic reaction, less heat may be released from the cellular concrete product 200. In some implementations, the reduced exothermic reaction may keep a host pipe in an annular setting from melting, for example (see FIG. 5). The cellular concrete product 200 may also be hydrophobic, and may not disperse when placed under water (i.e., it will remain cohesive and cure, even when submerged).

Further, because of the uniform size and distribution of the matrix of micro-bubbles within the cellular concrete product 200, the cellular concrete product 200 may be more resistant to fire and may provide better thermal insulation than conventional cellular concrete. Additionally, the cellular concrete product 200 may also be more resistant to sulfate attack than conventional cellular concrete. Still further, the cellular concrete product 200 may have filtration characteristics that are better than conventional cellular concrete due to the smaller and more consistently sized micro-bubbles. Lastly, the cellular concrete product 200 may be more durable, may require less maintenance, may have a longer life cycle, and may have better flexibility than conventional cellular concrete, again due to the smaller and more consistently sized micro-bubbles.

In various implementations, the cured cellular concrete product 200 has a density ranging between 160 to 1600 kilograms per cubic meter, with a compressive strength ranging between 70 to 7000 kPa (or 70 to 3500 kPa).

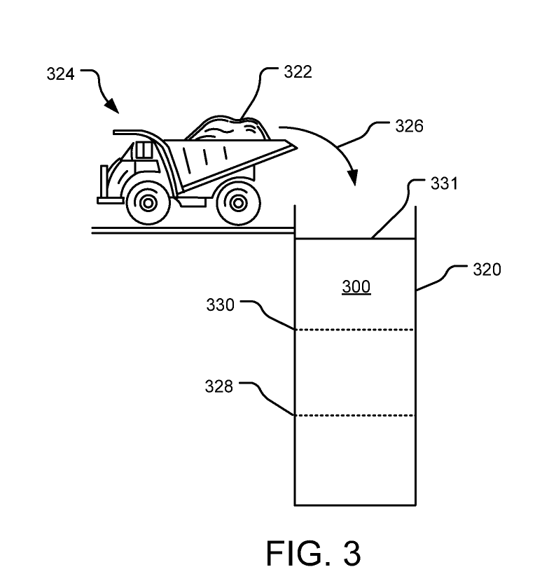

FIG. 3 illustrates an example placement of high-carbon cellular concrete 300 into a containment form 320. A high-carbon cellular concrete wet mixture 322 may be delivered to a work site via truck (e.g. truck 324), and pumped or otherwise dispensed into the example containment form 320, as illustrated by arrow 326. The containment form 320 may be man made (e.g., an assembly of wood, plastic, and/or concrete forms) or be naturally occurring (e.g., a geological formation). The containment form 320 may also have a variety of shapes, sizes, and depths, and the interior walls of the containment form 320 may be fluid pervious, semi-pervious, or impervious.

Placement of the high-carbon cellular concrete 300 may occur in stages (or lifts) to achieve a desired depth. For example, placement 1 may fill the containment form 320 to line 328, placement 2 may further fill the containment form 320 to line 330, and placement 3 may fill the container form 320 to a top 331 of the containment form 320. Staged placement keeps the weight of added wet mixture 322 from collapsing a matrix of micro-bubbles (not shown) within the cellular concrete 300 prior to curing.

The high-carbon cellular concrete 300 may be placed in deeper stages than conventional cellular concrete, due in part to the increased durability of the particularly small and consistently sized micro-bubbles within the high-carbon cellular concrete 300. In some implementations, a stage depth of 2.5 to 9 meters before curing may be achieved using the high-carbon cellular concrete 300 without destroying the matrix of micro-bubbles within the cellular concrete 300 prior to curing.

In some implementations, gelling properties of the wet mixture 322 (discussed above) may prevent or reduce seepage of the wet mixture 322 through holes or fissures (not shown) in the walls of the containment form 320. In some implementations, after the cellular concrete 300 is placed and begins to cure, the micro-bubbles begin to coalesce. When the cellular concrete 300 is completely cured and hardened, an open-pore, interconnected pervious capillary network may be formed by the connection of the micro-bubbles. In other implementations, the micro-bubbles do not interconnect and the cellular concrete 300 remains impervious.

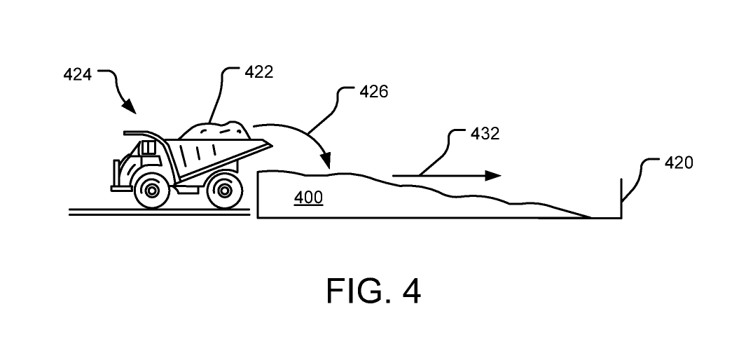

FIG. 4 illustrates another example placement of high-carbon cellular concrete 400 into a containment form 420. A high-carbon cellular concrete wet mixture 422 may be delivered to a work site via truck (e.g. truck 424), and pumped or otherwise dispensed into the example containment form 420, as illustrated by arrow 426. The containment form 420 may be man made (e.g., an assembly of wood, plastic, and/or concrete forms) or be naturally occurring (e.g., a geological formation). The containment form 420 may also have a variety of shapes, sizes, and depths, and the interior walls of the containment form 420 may be fluid pervious, semi-pervious, or impervious.

In placement of conventional cellular concrete, a wet mixture may lose its cellular bubble structure as it travels laterally away (e.g., in direction of arrow 432) from a point of placement of the conventional cellular concrete. The gelling, viscosity, and other properties of the high-carbon cellular concrete 400 allows it to travel laterally without it losing its cellular micro-bubble structure before it can be cured. The matrix of micro-bubbles (not shown) within the wet mixture 422 does not segregate or dissipate during placement of the cellular concrete 400.

In some implementations, gelling properties of the wet mixture 422 (discussed above) may prevent or reduce seepage of the wet mixture 422 through holes or fissures (not shown) in the walls of the containment form 420. In some implementations, after the cellular concrete 400 is placed and begins to cure, the micro-bubbles begin to coalesce. When the cellular concrete 400 is completely cured and hardened, an open-pore, interconnected pervious capillary network may be formed by the connection of the micro-bubbles. In other implementations, the micro-bubbles do not interconnect and the cellular concrete 400 remains impervious.

FIG. 5 illustrates an example placement of high-carbon cellular concrete 500 into an annular pipe setting 534. More specifically, the cellular concrete 500 (that includes anti-washouts) may be formed around pipe 536 that runs generally concentrically with an outer setting 538. In some implementations, the pipe 536 and the outer setting 538 are submerged under ground or a body of water. In various implementations, the pipe 536 remains nearly in the center of the outer setting 538, or it may shift with reference to the outer setting 538. The cellular concrete 500 secures the pipe 536 in place while allowing the flow of fluids through the pipe 536. The pipe 536 and the outer setting 538 may also have a variety of shapes, sizes, and depths, and the interior walls of the pipe 536 and the outer setting 538 may be fluid pervious, semi-pervious, or impervious.

When deploying a conventional cellular concrete in an annular pipe setting, the cellular concrete may be placed in lifts (alternatively, “stages” or “placements”). Here, three lifts are shown. Lift 1 may fill the annular pipe setting 534 from line 540 to line 542, lift 2 may further fill the annular pipe setting 534 from line 542 to line 544, and lift 3 may fill the annular pipe setting 534 from line 544 to line 546. Staged placement keeps the weight of added wet cellular concrete from collapsing a matrix of micro-bubbles (not shown) within the cellular concrete prior to curing and may prevent the pipe 536 from floating. Additionally, conventional cellular concrete may lose its cellular bubble structure as it travels laterally during an annular pipe placement before it is cured. Placing cellular concrete in multiple lifts is costly and time consuming.

The gelling, viscosity, and other properties of the wet high-carbon cellular concrete 500 may allow the cellular concrete 500 to be placed in fewer or one single lift without floating or displacing the pipe 536. For example, the cellular concrete 500 may be deployed at greater than 14 meters at a time without experiencing significant degradation of the matrix of micro-bubbles prior to curing.

In some implementations, gelling properties of the wet cellular concrete 500 may prevent or reduce seepage of the wet cellular concrete 500 through holes or fissures (not shown) in the walls of the pipe 536 and/or the outer setting 538. In some implementations, after the cellular concrete 500 is placed and begins to cure, the micro-bubbles begin to coalesce. When the cellular concrete 500 is completely cured and hardened, an open-pore, interconnected pervious capillary network may be formed by the connection of the micro-bubbles. In other implementations, the micro-bubbles do not interconnect and the cellular concrete 500 remains impervious.

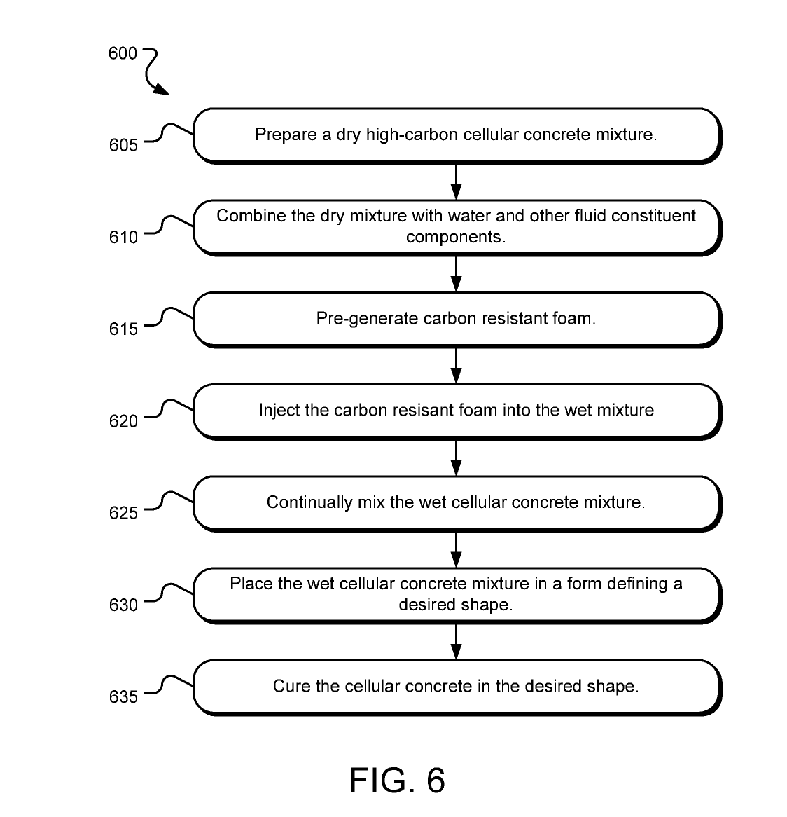

FIG. 6 illustrates example operations 600 for preparing and using high-carbon cellular concrete. Preparing operation 605 prepares a dry high-carbon cellular concrete mixture. The dry mixture includes at least a high-carbon ash, and may further include one or more of cement, aggregates, powdered foaming agent(s), powdered cellulose ether(s), and other powdered chemical and/or mineral admixtures. The constituent components of the dry mixture are blended together such that the resulting dry mixture has a substantially uniform composition. In various implementations, the dry mixture may contain 2% to 98% (or 5% to 95%) high-carbon ash, 2% to 98% (or 5% to 80%) cement, or 2% to 98% (or 5% to 95%) cement aggregates, by weight. The dry mixture may also include 0.01% to 30% by weight of cellulose ether(s) (or hydrocolloid polymer(s)).

A combining operation 610 combines the dry mixture with water and other fluid constituent components. In various implementations, the water can range from 5% to 80% (or 2% to 60%) by weight of the dry mixture. The other fluid constituent components may include fluid foaming agent(s), fluid cellulose ether(s), and other fluid chemical and/or mineral admixtures. The water and other fluid constituent components are mixed with the dry mixture together to form a wet high-carbon cellular concrete mixture. The temperature of the water may range from 0 to 50 degrees Celsius. In some implementations, the dry high-carbon cellular concrete mixture may reduce the coagulation caused by the addition of high-temperature water, thereby preserving eventual compressive strength of the high-carbon cellular concrete.

Combination (and mixing) of the water, the other fluid constituent components, and the dry mixture can be achieved in a drum mixer, a continuous mixer, or any other type of mixer that can create sufficient shear forces to thoroughly mix the constituent components to create a substantially uniform wet mixture. In implementations where powered foaming agent(s) are added in operation 605 and/or fluid foaming agent(s) are added in operation 610, the mixing is performed with sufficient shear forces to not only thoroughly mix the constituent components, but generate a matrix of micro-bubbles within the wet mixture, which will ultimately yield high-carbon cellular concrete.

A pre-generation operation 615 pre-generates carbon resistant foam. The carbon resistant foam can include non-ionic, cationic, and anionic surfactants (or “foaming agents”), a solvent (e.g., water), and/or pressurized air, for example. The surfactant mixture may also include methylcellulose, hydroxypropyl, and/or sodium chloride, for example. The surfactant mixture can range from 0.01% to 30% by volume of diluted water. The resulting foam may include 20% to 80% water, 80% to 98.8% foaming agent, and a unit weight of 8 kg/m³ to 560 kg/m³ (or 16 kg/m³ to 80 kg/m³) and may be enhanced using other chemical admixtures, such as plasticizers, anticoagulants, anti-washouts and/or polymers. Further, the pre-generated carbon resistant foam may comprise 10% to 95% of the base composite volume of the dry mixture.

An injection operation 620 injects the carbon resistant foam prepared in operation 615 into the wet mixture created in operation 610. The foam may have the unique ability to prevent the high-carbon dry mixture from breaking down bubbles within the foam and thereby prevent the cellular concrete from entering a false set. The injection operation 620 may be aided by adding the foam to a vessel where the wet mixture is being mixed in a continuous-type tumbling mixer, by an auger, or through a hose line through which the wet mixture slurry is passing in an in-line mixing configuration, or some other mixing apparatus. The pre-generation operation 615 and the injection operation 620 may be omitted where the powdered foaming agent(s) are added in operation 605 and/or the fluid foaming agent(s) are added in operation 610 and the foam is generated within the wet mixture in the combining (and mixing) operation 610.

A mixing operation 625 continually mixes the wet cellular concrete mixture to prevent the wet mixture from prematurely setting prior to placement. In various implementations, duration of the mixing operation 625 may range from 5 seconds to 90 minutes (or more precisely, 5 to 30 seconds). The mixing operation 625 may be performed by a low energy drum mixer, a high shear/speed colloidal mixer, or a volumetric/continuous mobile mixer, for example. In some implementations, a high sheer speed mixing of the wet cellular concrete may result in a better compressive strength of the resulting cured cellular concrete. The mixing operation 625 creates a gelled and foamed wet cellular concrete mixture that retains its cellular matrix of micro-bubbles for a time period sufficient to place and cure the cellular concrete product (see operations 630, 635, discussed in detail below). The wet cellular concrete may achieve and maintain a desired gelled consistency from about one minute to three hours after the mixing operation 625, for example.

A placing operation 630 places the wet cellular concrete in a form defining a desired shape for the cellular concrete. The form may take any available size or shape (see e.g., containment forms 320, 420 of FIGS. 3 and 4, respectively, and annular pipe setting 534 of FIG. 5, for example). The wet cellular concrete mixture can include millions of micro-bubbles. Because of the unique properties of the wet cellular concrete mixture (described in detail above), the wet mixture may be placed at depths greater than may normally be achieved with other cellular concrete mixtures. Further, the gelling, viscosity, and other properties of the wet cellular concrete mixture may also prevent or reduce leakage through holes, cracks or fissures in containment forms. Still further, the wet cellular concrete mixture may travel laterally at a greater distance that conventional cellular concrete without the matrix of micro-bubbles within the wet cellular concrete mixture dissipating.

A curing operation 635 cures the cellular concrete in the desired shape. Since the matrix of micro-bubbles does not significantly dissipate prior to curing, the cured cellular concrete product includes the matrix of micro-bubbles as an integrated and permanent feature of the high-carbon cellular concrete.

The logical operations making up the embodiments of the invention described herein are referred to variously as operations, steps, objects, or modules. Furthermore, it should be understood that logical operations may be performed in any order, adding or omitting operations as desired, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A wet high-carbon cellular concrete product comprising:
water;
a foaming agent; and
a high-carbon ash defining greater than 2% of the cellular concrete product by weight, wherein the cellular concrete product contains a distributed array of micro-bubbles that substantially maintain their presence in the cellular concrete product as it cures.

2. The wet high-carbon cellular concrete product of claim 1, wherein the high-carbon ash includes one or more of fly ash, bottom ash, rice hull ash, or other ashes with a loss of ignition of greater than 6%.

3. The wet high-carbon cellular concrete product of claim 1, wherein the high-carbon ash has pozzolanic properties.

4. The wet high-carbon cellular concrete product of claim 1, further comprising one or more cellulose ethers.

5. The wet high-carbon cellular concrete product of claim 1, further comprising one or more of cement, aggregates, chemical admixtures, and mineral admixtures.

6. The wet high-carbon cellular concrete product of claim 1, wherein the cellular concrete product has a viscosity of 500-90,000 cP prior to curing.

7. The wet high-carbon cellular concrete product of claim 1, wherein the cellular concrete product has less than 5% loss of volume as it cures.

8. A cured high-carbon cellular concrete product comprising:
a high-carbon ash defining greater than 3% of the cellular concrete product by weight; and
foaming agent residue that defines a distributed array of micro-bubbles within the high-carbon ash.

9. The cured high-carbon cellular concrete product of claim 8, wherein the cellular concrete product has a placement height exceeding 2.5 meters.

10. The cured high-carbon cellular concrete product of claim 8, wherein the high-carbon ash includes one or more of fly ash, bottom ash, rice hull ash, or other ashes with a loss on ignition of greater than 6%.

11. The cured high-carbon cellular concrete product of claim 8, further comprising one or more cellulose ethers.

12. The cured high-carbon cellular concrete product of claim 8, further comprising one or more of cement, aggregates, chemical admixtures, and mineral admixtures.

13. The cured high-carbon cellular concrete product of claim 8, wherein the micro-bubbles have a mean diameter of 500 to 1100 microns.

14. A method of manufacturing a high-carbon cellular concrete product comprising:
combining water, a foaming agent, and high-carbon ash to create a wet cellular concrete product that contains a distributed array of micro-bubbles that substantially maintain their presence in the cellular concrete product as it cures, wherein the high-carbon ash defines greater than 2% of the cellular concrete product by weight.

15. The method of claim 14, further comprising:
curing the wet cellular concrete product in a manner that has less than 5% loss of volume.

16. The method of claim 15, wherein the cellular concrete product has a viscosity of 500-90,000 cP prior to the curing operation.

17. The method of claim 14, further comprising:
placing the wet cellular concrete product with a placement height exceeding 2.5 meters.

18. The method of claim 14, wherein the high-carbon ash includes one or more of fly ash, bottom ash, rice hull ash, or other ashes with a loss of ignition of greater than 6%.

19. The method of claim 14, wherein the combining operation further includes adding cellulose ether to create the wet cellular concrete product.

20. The method of claim 14, wherein the combining operation further includes adding one or more of cement, aggregates, chemical admixtures, and mineral admixtures to create the wet cellular concrete product.
